(19) United States
(12) Patent Application Publication
(10) Pub. No.: US 2022/0397451 A1
(43) Pub. Date: Dec. 15, 2022

(54) ACOUSTIC SENSOR

(71) Applicant: NEC Corporation, Minato-ku, Tokyo (JP)

(72) Inventors: Yutaka YANO, Tokyo (JP); Eitaro MISUMI, Tokyo (JP); Jun MURAMATSU, Tokyo (JP)

(73) Assignee: NEC Corporation, Minato-ku, Tokyo (JP)

(21) Appl. No.: 17/770,713

(22) PCT Filed: Sep. 14, 2020
(86) PCT No.: PCT/JP2020/034647

§ 371 Date: Apr. 21, 2022

(30) Foreign Application Priority Data
Oct. 29, 2019 (JP) 2019-196746

(51) Int. Cl. G01H 9/00; H04R 23/00

(52) U.S. Cl. CPC G01H 9/004; H04R 23/008

(57) ABSTRACT

An acoustic sensor that uses an optical fiber and has a high directivity is provided. An acoustic sensor includes a sensing part and an interrogator. The sensing part has a sensing element composed of an optical fiber. The interrogator is connected to the sensing part, sends a pulse light P to the sensing part, and detects an acoustic wave sensed by the sensing part based on a reflected return light from the sensing part. The sensing element is composed of the optical fiber folded in such a way that it reciprocates a plurality of number of times along a directivity direction in which directional sensitivity is exhibited.

### TECHNICAL FIELD

The present invention relates to an acoustic sensor, and in particular, to a sound and vibration sensor that detects sound, which is a type of vibrations, using an optical fiber.

### BACKGROUND ART

When a sound wave is applied to an optical fiber, light that passes through the optical fiber is modulated. Then by detecting the reflected light or the transmitted light, sound waves in a remote place can be monitored. In general, this sensor system has recently been called Distributed Acoustic Sensing (DAS). Optical fiber sensors do not need to be supplied with power, and do not need electrical wiring as detected signals are sent by light. Therefore, optical fiber sensors have characteristics that they are not affected by lightning strikes and are less susceptible to induction noise.

An optical fiber sensor system used these days is composed of an optical fiber that senses sound or vibrations and a detection unit called an interrogator. The interrogator, which means “a person who conducts interrogations”, applies a probe light to an optical fiber, receives the reflected light or the transmitted light from the optical fiber, and detects states of sound waves or vibrations acting on the optical fiber.

The optical fiber, which is a part that senses the surrounding situation, serves as a medium that transmits an optical signal between the sensing part and the interrogator. While the term “sensor” normally refers to a sensing part, in the case of optical fiber sensors, it often refers to all of a part of an optical fiber and an interrogator. Further, the optical fiber is originally used as a transmission medium, and it is not clear which part of the entire optical fiber serves as a sensor. In the following description, the part of the optical fiber provided for sensing the surrounding situation is called a sensing element or a sensing part to distinguish this part from the other part of the optical fiber.

As a method of using an optical fiber as an acoustic sensor, a configuration in which an optical fiber, which serves as a sensor, is drawn in a coil shape, a spiral shape, or a mesh shape has been known (Patent Literature 1).

Microphones that sense a human audible range include omnidirectional microphones and directional microphones. The omnidirectional microphones, which are general-purpose microphones that do not require complicated adjustments, are suitable for an application where it is desired to make recordings with few mistakes. On the other hand, the directional microphones are suitable for an application of investigating a direction from which sound is coming and for professional applications where sound other than the sound emitted from a sound source, which is desired to be listened to, is to be excluded as much as possible.

Further, by employing a configuration in which a plurality of directional microphones are arranged in such a way that they face directions different from one another, a configuration in which they have sensitivities over a wide range in a form different from that of the omnidirectional microphone can be achieved. According to this configuration, it becomes possible, for example, to identify the orientation of a sound source and to observe a situation in which the sound source moves. However, in order to achieve this configuration, in addition to increasing the number of sensors, a capability of processing the output data is also required.

It is generally known that, in a sensor that detects sound or vibration using an optical fiber, a sensing part has directivity. It is also known that while the sensing part is highly sensitive to sound waves that travel in a direction along the longitudinal direction of an optical fiber linearly arranged, it is not sensitive to sound waves coming from just beside the optical fiber. As a method of homogenizing such directivity and achieving omnidirectional characteristics, a configuration in which an optical fiber is helically wound has been proposed (Patent Literature 2-4).

Patent Literature 4 explains, in paragraph [0003], the principle that an optical fiber detects sound waves and a reason why directivity occurs. This paragraph discloses that there are two effects of sound waves on an optical fiber. The first effect is an effect that a distance between light scattering points is changed (since compressional waves of sound are transmitted through the optical fiber), that is, an optical fiber is stretched or compressed, and the second effect is an effect that the light speed changes (that is, a refractive index changes). When the situation at each point of the optical fiber is detected by making a probe light incident on the optical fiber and monitoring its backscattered light, the first effect can be detected only when the longitudinal direction of the optical fiber is stretched or compressed, and therefore has a strong directivity. On the other hand, the second effect is as weak as a fraction of that of the first effect, although it has no directivity. Therefore, a general DAS detects sound waves or vibrations only using the first effect. Therefore, such a DAS has directivity to detect sound waves or vibrations propagating in the direction in which the optical fiber is extended with a high sensitivity.

Techniques of monitoring the situation in which each point of the optical fiber is stretched or compressed by making a probe light incident on an optical fiber and monitoring its backscattered light are disclosed in, for example, Patent Literature 10 and 11 and Non-Patent Literature 2.

As disclosed in, for example, Patent Literature 2 and 3, a cable configuration in which an optical fiber (sensing part) is helically wound has been previously employed in the field of optical fiber sensing. It is recognized that this configuration also has an effect of homogenizing directivity of sound wave detection in DAS, and a technique of optimizing it is disclosed, for example, in Patent Literature 4.

Another configuration in which, when the sensing part is configured, sound or vibration is sensed by an object other than an optical fiber, and the sensed vibration is further transmitted to the optical fiber for sensing, is also disclosed (Patent Literature 5 and 6).

Another configuration in which directivity that an optical fiber sensor has is used is also disclosed (Patent Literature 7). In this related art, however, a configuration in which an optical fiber is wound around a core rod (i.e., mandrel), similar to those disclosed in Patent Literature 5 and 6, is assumed to be a basic element. Sound waves are first sensed by the core rod, and its vibrations are read by stretch or compression of the optical fiber wound around it. Further, as an arrangement orientation, only a form in which optical fibers are directed to three axes orthogonal to one another is disclosed. In this configuration, optical fiber sensors having a plurality of directivities are arranged orthogonally in three axes. That is, a plurality of directional microphones are arranged in directions different from one another. Accordingly, an optical fiber sensor that is sensitive to all the orientations and can measure orientation and movement of a sound source is provided.

Further, a technique of grouping long optical fibers for sensors into a sheet-like form to facilitate handling is disclosed (Patent Literature 8 and 9).

### CITATION LIST

### Patent Literature

[Patent Literature 1] U.S. Pat. No. 4,162,397
[Patent Literature 2] U.S. Pat. No. 4,524,436
[Patent Literature 3] Japanese Unexamined Patent Application Publication No. S61-151485
[Patent Literature 4] International Patent Publication No. WO 2013/090544
[Patent Literature 5] Japanese Unexamined Patent Application Publication No. H02-107927
[Patent Literature 6] Japanese Unexamined Patent Application Publication No. H06-339193
[Patent Literature 7] International Patent Publication No. WO 2007/130744
[Patent Literature 8] Japanese Unexamined Patent Application Publication No. S60-210791
[Patent Literature 9] Japanese Unexamined Patent Application Publication No. H08-086920
[Patent Literature 10] Japanese Unexamined Patent Application Publication No. S59-148835
[Patent Literature 11] Japanese Patent No. 2746424

### Non-Patent Literature

[Non-Patent Literature 1] Y. M. Sabry, D. Khalil, and T. Bourouina, “Monolithic silicon-micromachined free-space optical interferometers onchip”, Laser Photonics Reviews, 2015, vol. 9, no. 1, pp. 1-24.
[Non-Patent Literature 2] R. Posey Jr., G. A. Johnson and S. T. Vohra, “Strain Sensing based on coherent Rayleigh scattering in an optical fibre”, Electronics Letters, 2000, vol. 36, No. 20, pp. 1688-1689.

### SUMMARY OF INVENTION

### Technical Problem

Needless to say, it is desirable for a sensor that detects vibrations of a medium such as sound waves to have as sharp as possible directivity. In order to achieve sharp directivity, it is required to proactively use directivity that an optical fiber sensor has and thereby improve the directivity of the optical fiber sensing part, which is an acoustic sensor.

Further, there has been no technique for obtaining a sensor group that exhibits sharper directivity or are able to change the angle of directivity without tilting elements by combining a plurality of sensor units having sharp directivity.

The present invention has been made in view of the aforementioned circumstances and aims to provide an acoustic sensor that uses an optical fiber and has a high directivity.

### Solution to Problem

An acoustic sensor according to one aspect of the present invention includes: a sensing part including a sensing element composed of an optical fiber; and an interrogator that is connected to the sensing part, sends a pulse light to the sensing part, and detects a sound wave vibration to be sensed by the sensing part based on a reflected return light from the sensing part, in which the sensing element is composed of the optical fiber folded in such a way that it reciprocates a plurality of number of times along a directivity direction in which directional sensitivity is exhibited.

### Advantageous Effects of Invention

According to the present invention, it is possible to provide an acoustic sensor that uses an optical fiber and has a high directivity.

### BRIEF DESCRIPTION OF DRAWINGS

FIG. 1 is a perspective view of a sensing part according to a first example embodiment;

FIG. 2 is a diagram schematically describing the shape of the sensing part in a plan view;

FIG. 3 is a diagram schematically showing a configuration of an acoustic sensor according to the first example embodiment;

FIG. 4 is a diagram showing a relation between the sensing part and a light pulse;

FIG. 5 is a diagram schematically describing the shape of a modified example of the sensing part in a plan view;

FIG. 6 is a diagram schematically showing a configuration of the sensing part formed on a sheet member;

FIG. 7 is a diagram showing a configuration of an optical fiber ribbon;

FIG. 8 is a diagram showing an example of a V groove array;

FIG. 9 is a diagram showing one example of the exterior of a light folded-back part package in which the optical fiber ribbon and a light folded-back circuit are coupled to each other;

FIG. 10 is a diagram showing a first configuration example of the light folded-back part;

FIG. 11 is a diagram showing a second configuration example of the light folded-back part;

FIG. 12 is a diagram showing a third configuration example of the light folded-back part;

FIG. 13 is a diagram schematically showing a configuration of a sensing part according to a second example embodiment;

FIG. 14 is a diagram schematically showing a configuration of a modified example of the sensing part according to the second example embodiment;

FIG. 15 is a diagram schematically showing a configuration of a sensing part according to a third example embodiment;

FIG. 16 is a diagram schematically showing a configuration of the sensing part according to the third example embodiment;

FIG. 17 is a diagram schematically showing a configuration of a sensing part according to a fourth example embodiment;

FIG. 18 is a diagram schematically showing a configuration of a first example of a sensing part according to a fifth example embodiment;

FIG. 19 is a diagram schematically showing a configuration of a second example of the sensing part according to the fifth example embodiment;

FIG. 20 is a diagram schematically showing a configuration of a third example of the sensing part according to the fifth example embodiment;

FIG. 21 is a diagram schematically showing a configuration of a first example of a sensing part according to a sixth example embodiment;

FIG. 22 is a diagram schematically showing a modified configuration of the first example of the sensing part according to the sixth example embodiment;

FIG. 23 is a diagram schematically showing a configuration of a second example of the sensing part according to the sixth example embodiment; and

FIG. 24 is a diagram schematically showing a configuration of a sensing part according to a seventh example embodiment.

### DESCRIPTION OF EMBODIMENTS

Hereinafter, with reference to the drawings, example embodiments of the present disclosure will be described. Throughout the drawings, the same components are denoted by the same reference symbols and redundant descriptions will be omitted as appropriate.

### First Example Embodiment

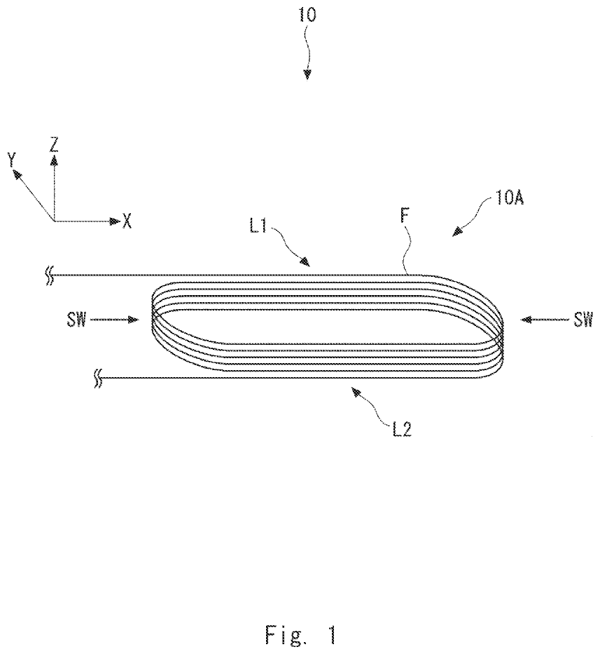

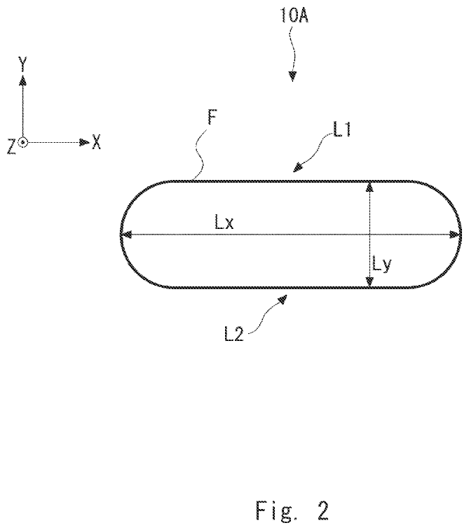

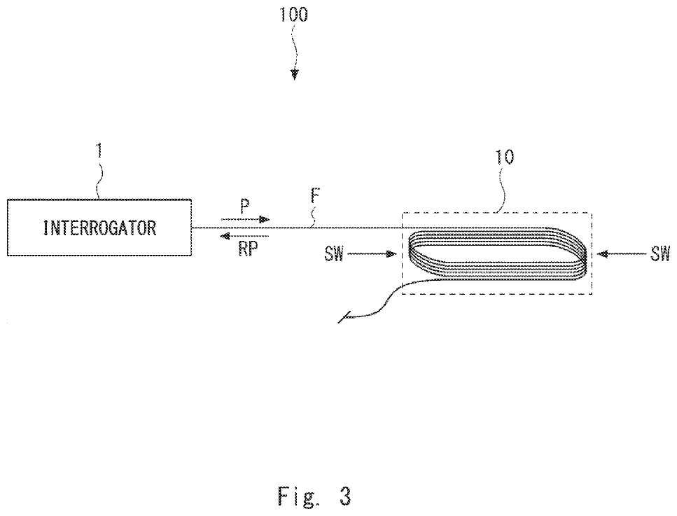

A sensing part according to a first example embodiment will be described with reference to a perspective view shown in FIG. 1 and a plan view shown in FIG. 2. A sensing part 10 is connected to, for example, an interrogator 1, like in an acoustic sensor 100 shown in FIG. 3, thereby sensing sound or vibration coming thereto. In the following description, a basic unit that composes a sensing part is referred to as a sensing element. The term “sensing part” denotes a combination of one or more sensing elements and a sound insulation material, a shape retaining material or the like that will be described later. A sensing element that composes the sensing part shown in FIG. 1 is denoted by the symbol 10A. The sensing element 10A shown in FIGS. 2 and 3 is a configuration example of the most basic sensing element formed by winding an optical fiber F by one or more turns. In this example embodiment, the interrogator 1 outputs a pulse light P to the sensing part 10 and receives its return light (reflected return light) RP. It is desirable that the sensing element 10A be formed to have an oval shape in a plan view, such as an egg shape, ellipsoidal, elliptical, or obround. Since the sensing element 10A has the aforementioned shape, the sensing part 10 is highly sensitive to vibration SW such as sound waves or pressure arriving in the long diameter direction of the winding (the X-axis direction in the drawings), that is, it exhibits directivity. In this example embodiment, an optical fiber wound in a flat coil shape will be described as a general shape of the sensing element.

In the following description, vibrations detected by the acoustic sensor are various vibration phenomena including not only longitudinal waves such as sound waves or pressure but also transverse waves.

As shown in FIGS. 2 and 3, straight line parts of the sensing element 10A arranged in parallel to each other are denoted by L1 and L2. The direction in which the straight line parts L1 and L2 are extended is the X direction and the direction perpendicular to the X direction (first direction) on the paper is the Y direction (second direction). A vibration propagation medium around the sensing element may be various elements such as air, water, or underground (earth and sand, rock etc.) In general, the optical fiber is stretched or compressed while the compressional waves (longitudinal waves) propagate therethrough, and this state is detected by the interrogator. Therefore, the sensing element 10A has selective sensitivity, that is, directivity, to the vibration wave SW that propagates in the direction in which the straight line parts L1 and L2 are extended (X direction). In FIG. 3, the long diameter of the X direction, which is the maximum dimension of the outer diameter of the sensing element (winding) formed of the sensing element 10A, is denoted by Lx and the short diameter of the Y direction, which is the minimum dimension thereof, is denoted by Ly.

In order to enhance the sensitivity to the vibration wave that is propagated in the X direction, the sensing element is formed in such a way that Lx becomes larger than Ly (Lx>Ly). For example, in order to enhance the sensitivity to the vibration propagating in the X direction, Lx may be twice as large or larger than Ly (Lx≥2Ly).

In order to achieve sharp directivity, that is, in order to increase the ratio of Lx to Ly (Lx/Ly), it is desirable that Ly be short. However, since there is a limitation on the minimum bending radius in optical fibers, the shape of the sensing element is also restricted. For example, the minimum bending radius of a general optical fiber that is in compliance with International Telecommunication Union Telecommunication Standardization Sector (ITU-T) G.652 is 30 mm. In recent years, an optical fiber that is in compliance with ITU-T G.657.B3 in which the allowable minimum bending radius is reduced to be as small as 5 mm by enhancing confinement of light has been put into practical use as well. The diameter Ly may be shortened by using this optical fiber.

Next, design parameters of the sensing element 10A will be discussed. For example, in Patent Literature 1, Lx is set to be equal to or smaller than ½ of the wavelength of sound to be observed. While it is desirable that the dimension of Lx be small from the viewpoint of downsizing the sensing element 10A, the detection sensitivity is lowered by shortening the dimension of Lx. Further, by increasing the number of turns T (the total length Lt of the winding becomes naturally long), the sensitivity can be improved. However, even when the total length Lt of the winding is made large, the sensitivity is limited by a spatial resolution Lp of the acoustic sensor 100.

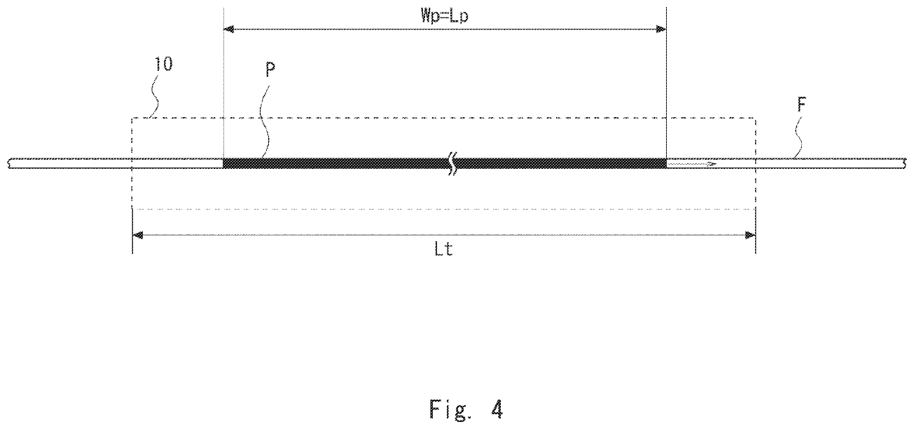

FIG. 4 shows a relation between the sensing element and the light pulse. In the example shown in FIG. 4, in order to compare the total length Lt of the sensing element 10A with a pulse width Wp of a light pulse P, the winding of the sensing element 10A is unwound and illustrated as a linear optical fiber. In the acoustic sensor 100, the light pulse P is propagated through the optical fiber in which the sensing element 10A is provided, and when the light pulse passes through a part of the sensing element 10A that sound waves are arriving, a scattering point that generates Rayleigh scattering is shaken, which causes the phase of the light pulse to be modulated. In this example, the total length Lt of the sensing element 10A is larger than the pulse width Wp of the light pulse P. In this case, regardless of the total length Lt of the sensing element 10A, the light pulse P is modulated only by sound that has reached the section of the pulse width Wp. That is, in this example, the modulation is determined by the pulse width Wp, not by the total length Lt of the sensing element 10A. In the following description, the pulse width of the light pulse P is denoted by Wp and the spatial resolution of the acoustic sensor 100 is denoted by Lp. (While the spatial resolution Lp can be made larger than the pulse width Wp by an arithmetic operation, it cannot be made smaller than the pulse width Wp.)

That is, it will be understood that, even when the number of turns T of the winding that forms the sensing element of the sensing element 10A is increased and the total length Lt is made longer than the spatial resolution Lp, the sensitivity is limited by the spatial resolution Lp.

From the above discussion, when the speed of the sound to be detected in the medium is denoted by v and the upper limit of the acoustic wave frequency band to be observed is denoted by f_{c}, since v=λ×f_{c}, the following expressions are established regarding the design of the winding. By designing Lx, Ly and the number of turns T of the winding in such a way that the following Expressions [1] and [2] are satisfied, preferable design values of the winding can be obtained.

$$Lx \leq \frac{v}{2 {f}_{c}} \qquad [ 1 ]$$

$$T = \frac{Lp}{2 ( Lx + Ly )} \qquad [ 2 ]$$

Now, using Expressions [1] and [2], specific examples of the design values of the winding are shown.

When f_{c}=5 kHz, Wp=Lp=8 m, and v=1500 m (in water), Lx≤15 cm is established. When Lx=15 cm and Ly=3 cm, the appropriate design value is T=23 (turns). Calculation example 1

When fₑ=100 Hz, Wp=Lp=8 m, and v=1500 m (in water), Lx≤7.5 m is established. When Lx=1 m and Ly=3 cm, the appropriate design value is T=4 (turns). Calculation example 2

Needless to say, when Lx and T are made smaller than those derived from Expressions [1] and [2], the sensitivity is lowered. Even when T is made larger than that derived from Expressions [1] and [2], this leads to an increase in the number of optical fibers that do not contribute to improving characteristics including sensitivity.

Described above is based on the assumption that the sensing element has an oval shape composed of a wound optical fiber. Even when there is some deformation, the effects of the present invention are not impaired. Some deformation may occur depending on the situation in which the sensing element is implemented. For example, a degree of influence when the ring having an oval shape is twisted into a figure-8 shape will be estimated.

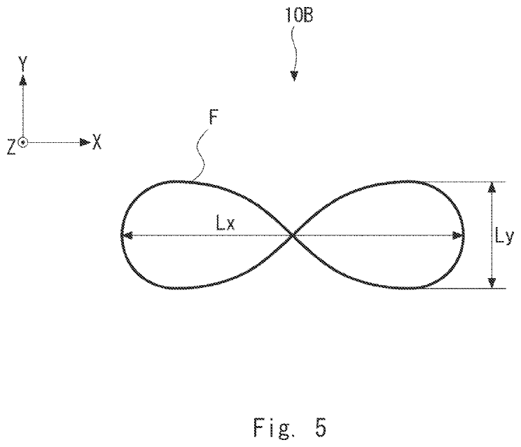

A sensing element 10B shown in FIG. 5, which is a twisted form of the sensing element 10A, has a figure-8 shape. In this case, of the optical fiber lengths of the sensing element 10B, the length of the optical fiber in the X direction is 2 Lx, like in the sensing element 10A, whereas the length of the optical fiber in the Y direction is 4Ly, which is twice as large as that of the sensing element 10A. If it is assumed that the directivity is simply proportional to the ratio of the X direction of the optical fiber length to the Y direction of the optical fiber length, then directivity of the sensing element 10B ends up being reduced to almost half the directivity of the sensing element 10A. Nevertheless, it will be understood that the sensing element 10B operates as a sensing element having directivity in the X direction as long as the ratio of the X direction to the Y direction is much larger than 2.

While the explanation has been given using the optical fiber wound into a flat coil shape as an example of the shape in which the sensing element is obtained in this example embodiment, the optical fiber is not necessarily wound. In order to obtain the effects of the present invention, it is required to fold the optical fiber in a direction parallel to the direction in which directivity is to be obtained and reciprocate it, shorten the path of the optical fiber in a direction parallel to the direction in which directivity is not to be obtained as much as possible, and make the ratio thereof large. Since it is difficult to sharply bend an optical fiber, a flat coil shape is one of preferable examples.

A configuration example in which the aforementioned sensing element is mounted in a package so that it can be easily handled will be described. Since sound waves reach the sensing element 10A through a medium such as air and water that transmits sound waves, the sensing element 10A needs to be in touch with the medium that transmits the sound waves. However, the optical fiber tends to be easily damaged due to its low mechanical strength. It is therefore desired to provide a member (protection member) for protecting the optical fiber. Further, since the optical fiber alone is not sufficient to maintain its rod-like shape, a shape retaining member for maintaining its shape is required. The protection member and the shape retaining member are preferably made of a material that does not disturb propagation of sound waves or vibrations to be measured to the optical fiber as much as possible.

Specifically, in order to retain and protect the shape of the optical fiber, a configuration in which the optical fiber wound in a coil shape is potted by resin (resin potting), or a folded optical fiber is formed into a sheet-like shape and the obtained sheet is further wound into a cylindrical shape may be conceived.

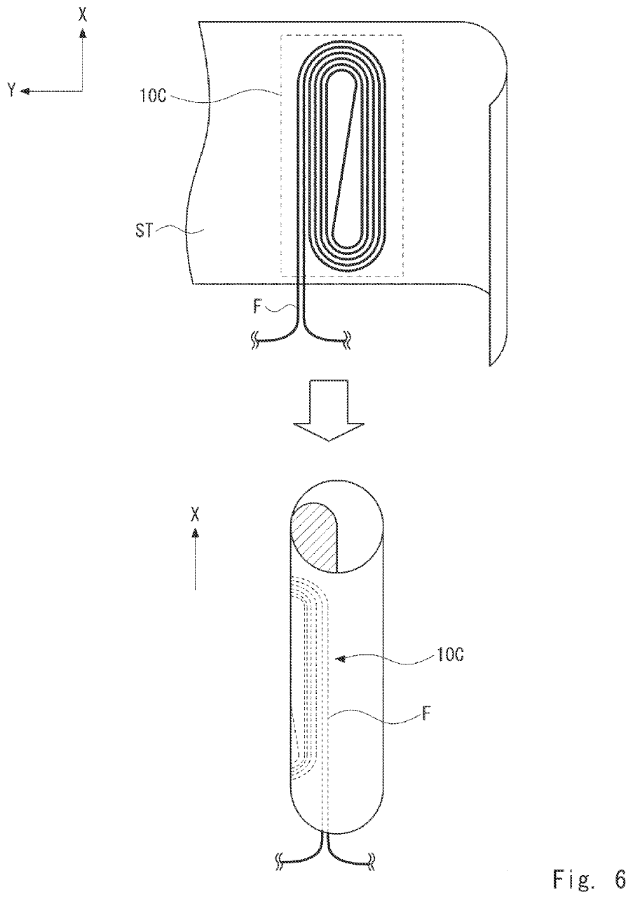

FIG. 6 schematically shows a configuration of a sensing element 10C formed on a sheet member. The sensing element 10C, which is a modified example of the sensing element 10A, is formed by winding a fiber pair formed by folding back one optical fiber in a swirl shape on the X-Y plane. As shown in the upper stage of FIG. 6, the optical fiber is wound in a spiral shape in a clockwise direction (a first winding direction) toward the central axis of the winding of the sensing element 10C. Then, the optical fiber is folded back near the central axis in such a way that the winding direction is changed to a counterclockwise direction (a second winding direction). After that, the optical fiber is wound in a spiral shape in the counterclockwise direction toward the outer circumferential direction of the winding of the sensing element 10C. Accordingly, the winding can be formed on the sheet member ST.

As shown in the lower stage of FIG. 6, the sheet member ST can be wound into a cylindrical shape about the X-axis direction. Accordingly, even after the sheet member ST is wound up, the directivity is maintained since the long diameter direction of the sensing element 10C remains in the X-axis direction. The sensing element 10C is wrapped by the sheet member ST as the sheet member ST is wound up, whereby the sensing element 10C can be reliably protected.

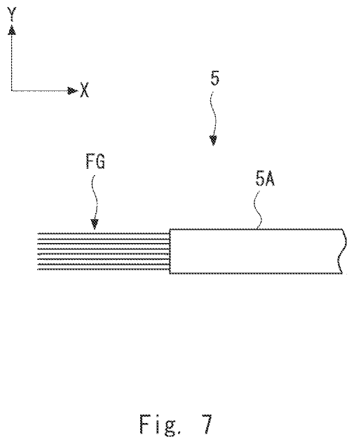

Next, a configuration example in which the sensing element 10A is obtained using a widely used optical fiber ribbon will be described. FIG. 7 shows a configuration of an optical fiber ribbon 5. The optical fiber ribbon 5 includes a plurality of optical fibers FG that are covered with a coating 5A and are arranged in line with one another in a tape shape. By connecting end points of the optical fibers of the optical fiber ribbon in such a way that they are folded back, a configuration that is similar to the one in which optical fibers are wound can be obtained. By using the optical fiber ribbon, it becomes easy to stably manage optical fibers, which are mechanically unstable and can be easily damaged.

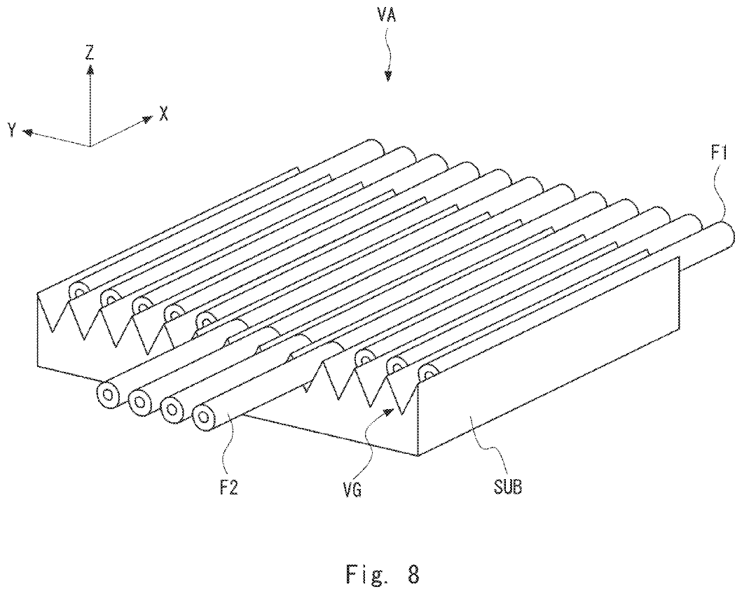

A configuration example of the folded-back part of each of end points in a configuration in which the optical fiber ribbon is used will be described below. A general configuration as a method of connecting the end parts of the optical fiber ribbon and the light folded-back part is a connection by passive alignment using a V groove array shown in FIG. 8. By integrally molding the V groove array in an optical input/output part of the light folded-back part, removing the coating at the ends of the optical fiber ribbon, placing the end parts of the optical fiber ribbon on the V groove array, and fixing the end parts of the optical fiber ribbon, they can be coupled to the light folded-back part.

FIG. 8 shows an enlarged view of the coupling part by the V groove array. The V groove array VA includes a substrate SUB where a plurality of V grooves VG are aligned, and optical fibers are placed on the respective V grooves VG. As shown in FIG. 8, optical fibers F1 and F2 are bonded to each other (butt joint) on the V grooves VG. Since it is necessary to sufficiently prevent reflection at the bonded part, the surrounding thereof may be filled with, for example, a refractive index matching liquid.

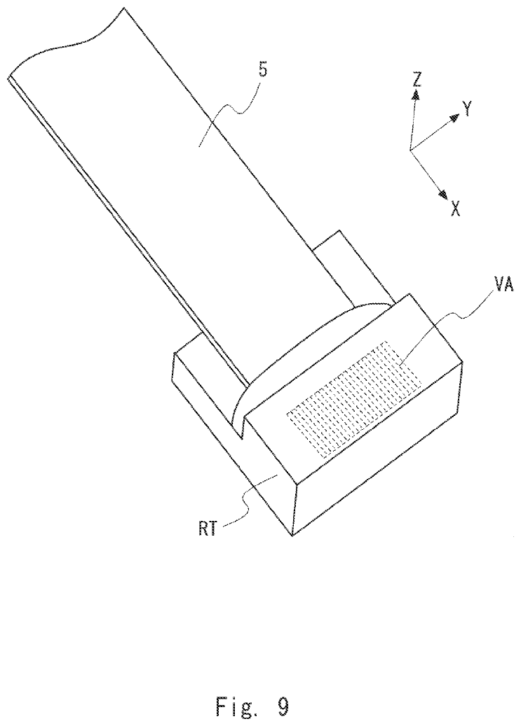

FIG. 9 shows an example of the exterior of a light folded-back part package in which the optical fiber ribbon and the light folded-back circuit are coupled to each other. In a light folded-back part package RT of the sensing element that uses the optical fiber ribbon, the light folded-back circuit and the optical fiber ribbon 5 are optically connected to each other using the V groove array VA and are fixed so as to have a strength that can be handled as the sensing element.

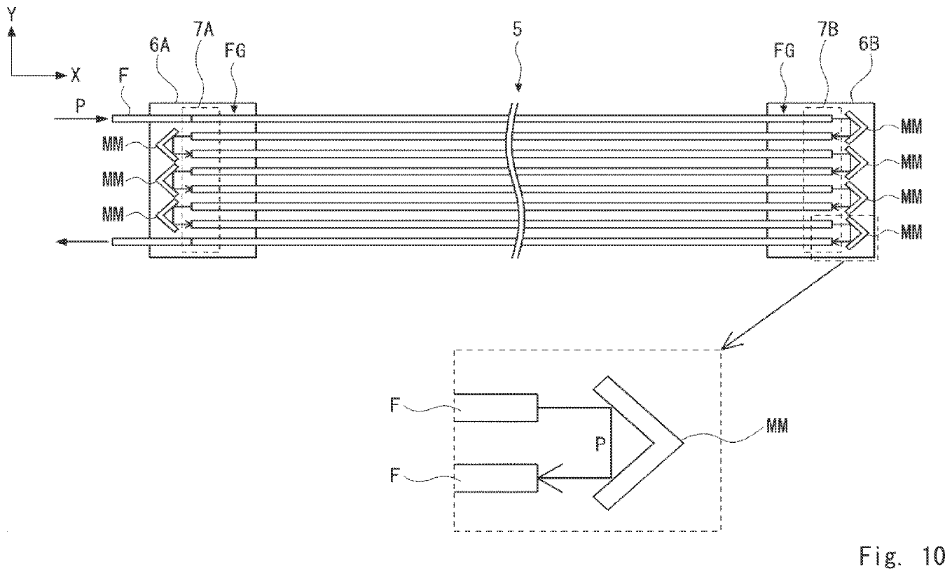

Hereinafter, with reference to FIGS. 10-12, three specific configuration examples of the light folded-back part will be described. In FIG. 10, the coating 5A of the optical fiber ribbon 5 is not shown in order to facilitate understanding of paths of optical fibers.

FIG. 10 shows a first configuration example of the light folded-back part. For example, the V groove array described above and a micro-mirror array are manufactured on an Si substrate by etching or the like. (See, for example, Non-Patent Literature 1 for a technique for creating such an optical circuit.) In this example, the optical fiber ribbon 5 is extended between Si optical circuits 6A (this is referred to also as a first optical circuit) and 6B (this is referred to also as a second optical circuit), which are light folded-back parts, and the optical fibers on the respective ends of the optical fiber ribbon 5 are aligned by V groove arrays 7A and 7B of the Si optical circuits 6A and 6B. One or more micro mirror MM (this is referred to also as a first mirror), which is intended to optically connect the end parts of the two optical fibers, is provided in the Si optical circuit 6A so as to be opposed to the aligned optical fibers. A measure for suppressing Fresnel reflected return light at the ends of the optical fibers such as filling the optical path with a refractive index matching fluid is taken. In the Si optical circuit 6A, optical fibers F are connected to the end parts of the two optical fibers of the optical fiber ribbon 5, and one of them (this is referred to also as a connecting optical fiber) is connected to the interrogator 1 or another sensing element. (The connection with the connecting optical fiber F may be made after going out to the outside, after passing through the optical circuit 6A.) One or more micro mirror MM (this is referred to also as a first mirror) is provided in the Si optical circuit 6B as well in such a way that the micro mirror MM is opposed to the aligned optical fibers. Accordingly, the Si optical circuits 6A and 6B and the optical fiber ribbon form an optical path in which light reciprocates a specified number of times, whereby the sensing element is formed.

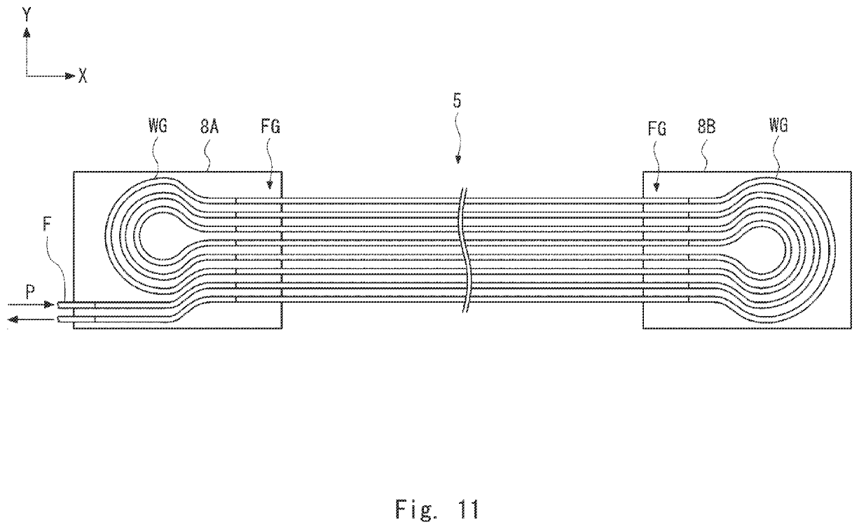

FIG. 11 shows a second configuration example of the light folded-back part. In FIG. 11, SiO₂ optical waveguides, which are known techniques for forming an optical circuit, is used. In this example, light folded-back circuits 8A (this is referred to also as a first optical circuit) and 8B (this is referred to also as a second optical circuit) formed of curved SiO₂ optical waveguides WG are provided in the respective ends of the optical fiber ribbon 5. In this configuration, in place of the micro mirrors shown in FIG. 10, the end parts of two optical fibers are connected by the SiO₂ optical waveguides WG. In this case, the allowable bending radius of the SiO₂ optical waveguides is about a few millimeters, whereby the dimensions of the elements become larger than those of the Si optical circuit in the first example.

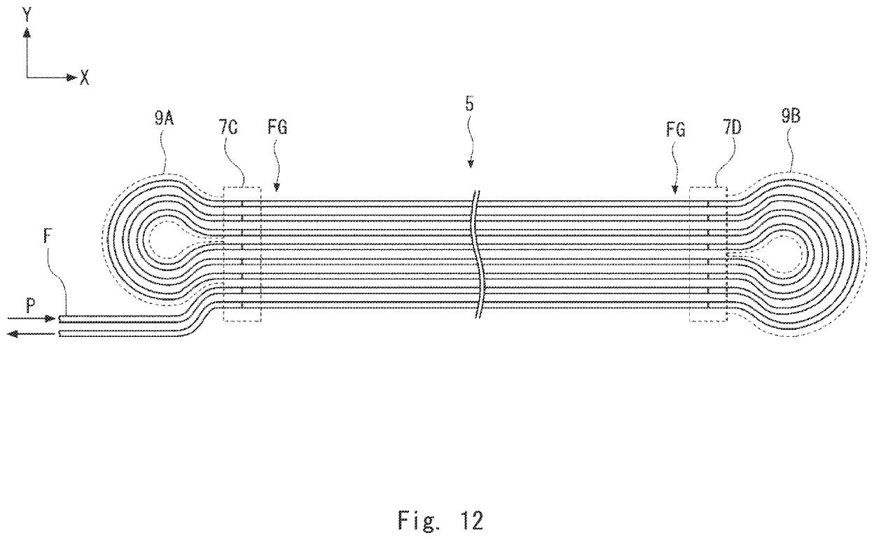

FIG. 12 shows a third configuration example of the light folded-back part. In this example, in place of the SiO₂ optical waveguides according to the second example, an optical fiber ribbon is also used to fold back the light. The respective ends of the optical fiber ribbon 5 to be folded back are folded back by optical fiber ribbons 9A and 9B that are bent. In FIG. 12, the outlines of the coating of the optical fiber ribbons 9A (this is referred to also as a first optical circuit) and 9B (this is referred to also as a second optical circuit) are shown by broken lines. In this case, since the optical fiber ribbons 9A and 9B of the folded-back parts include optical fibers, the minimum bending radius of about a few centimeters needs to be secured (while the size of the folded-back parts shown in FIG. 11 and that shown in FIG. 12 are shown to be similar to each other, this is because of the convenience of drawing them and the folded-back parts shown in FIG. 12 are several times larger than the folded-back parts shown in FIG. 11). In this case, the optical fibers of the optical fiber ribbons 9A and 9B of the folded-back parts become sensitive to vibrations. It is therefore desirable to retain the optical fibers taking into consideration appropriate soundproofing and vibration isolation in order to prevent them from receiving unnecessary vibrations.

The optical fiber ribbon 5 and the optical fiber ribbons 9A and 9B are connected, for example, by V groove arrays 7C and 7D. The V groove arrays 7C and 7D may be formed on an Si substrate or may be formed on an SiO₂ substrate. A widely used device for fusion splicing optical fiber ribbons may instead be used, which requires the folded-back parts of the optical fiber ribbons 9A and 9B to be formed by using, for example, the technique of the optical fiber sheet used in FIG. 6 as well in such a way that the connection end points of the folded-back parts have a shape the same as that of the optical fiber ribbons.

Needless to say, in the application of optical fiber sensing, it is important to suppress the reflection at the connection points of the folded-back parts to a sufficiently small level in any one of the first to third examples. While the connection method using the V groove arrays has been described in the above examples, general fusion splicing may instead be used as a method of connecting optical fibers.

As described above, according to the above configurations, it is possible to obtain an acoustic sensor having directivity that exhibits a high sensitivity in the long diameter direction of the optical fiber winding that forms the sensing element.

### Second Example Embodiment

The sensing element having directivity has been described in the first example embodiment. According to this configuration, however, it is impossible to distinguish whether a sound wave has come from the right or from the left. In view of this problem, in a second example embodiment, a configuration that makes it possible to distinguish whether a sound wave has come from the right or from the left will be described.

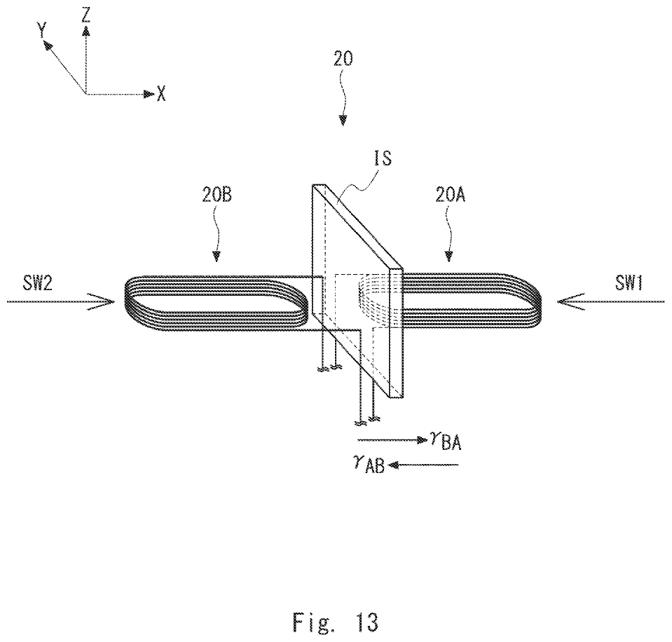

FIG. 13 schematically shows a configuration of a sensing part 20 according to the second example embodiment. The sensing part 20 includes two sensing elements, that is, a sensing element 20A (this is referred to also as a first sensing element) and a sensing element 20B (this is referred to also as a second sensing element). The sensing elements 20A and 20B each include a configuration similar to that of the sensing element of the sensing element 10A according to the first example embodiment. The sensing elements 20A and 20B are arranged in line with each other in the X direction in such a way that the long diameters thereof are along the axis parallel to the X direction.

A sound insulation member IS is provided between the sensing element 20A and the sensing element 20B. Accordingly, while a sound wave propagated from the right (X+ side) of FIG. 13 reaches the sensing element 20A, this sound is insulated by the sound insulation member IS and does not reach the sensing element 20B. Likewise, while a sound wave propagated from the left (X− side) of FIG. 13 reaches the sensing element 20B, this sound is insulated by the sound insulation member IS and does not reach the sensing element 20A.

Therefore, the sound wave propagated from the right (X+ side) of FIG. 13 is sensed by the sensing element 20A and the sound wave propagated from the left (X− side) of FIG. 13 is sensed by the sensing element 20B. Accordingly, with this configuration, it becomes possible to determine the incoming direction of each of the two sound waves, which is impossible to achieve in the first example embodiment.

Note that the sound insulation member IS may be composed as a sound insulation member that absorbs sound or may be composed as a reflection member that reflects sound. Needless to say, when the reflection member is used, the arrangement and the like of the reflection member should be devised so as to prevent such a problem that a reflected sound is further reflected in any part of the sensing elements and thus an echo occurs.

In this configuration, even in a case in which sound cannot be completely muted by the sound insulation member IS, one of the two sensing elements strongly senses sound waves. In this case, by performing arithmetic processing of obtaining the difference between results of sensing in the two sensing elements, sound waves may be preferably detected.

When the output of the sensing element 20A is denoted by A and the output of the sensing element 20B is denoted by B, a sound wave SW1 propagated from the right (X+ side) and a sound wave SW2 propagated from the left (X− side) can be obtained from the following expressions. It is therefore possible to reduce the influence of the sound that cannot be completely muted by the sound insulation member IS.

PA=A−B·γ_{BA}

PB=B−A·γ_{AB}

Here, coefficients γ_{BA} and γ_{AB} are sound wave transmittances of the sound insulation member IS obtained by a calibration operation in advance. In the calibration operation, γ_{AB} can be obtained by calculating B/A in a state in which sound is propagated from the right (γ_{AB}=B/A) and γ_{BA} can be obtained by calculating A/B in a state in which sound is propagated from the left (γ_{BA}=A/B).

The configuration according to the second example embodiment is the one in which two sensing elements 10A are used. In the following description, assuming that the above configuration forms a basic unit, a configuration in which a plurality of basic units are combined with each other will be described. In the following description, for the sake of convenience of explanation, the configuration according to the second example embodiment is referred to also as a sensing element.

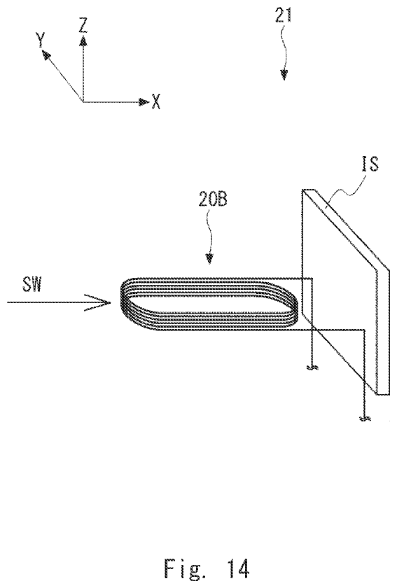

As a modified example of the second example embodiment, a sensing part 21 shown in FIG. 14 will be described. When it is not required to detect sound coming from the back side of the sensing element 20B, there is no need to use two sensing elements 10A and it is sufficient that only one sensing element 10A be used. Sound coming from the side opposite from the direction whose sound is desired to be sensed is insulated by the sound insulation member IS. This sensing part 21 is a complex in which the sensing element 10A and the sound insulation member IS are combined with each other. In the following description, assuming that this configuration forms a basic unit, a configuration in which a plurality of basic units are combined with each other will be described. Therefore, for the sake of convenience of the explanation, the configuration of the sensing part 21 will be referred to as a sensing element.

### Third Example Embodiment

Assuming that the sensing element described above forms a basic unit, an application form in which a plurality of basic units are combined with each other will be described below. A composite part in which a plurality of sensing elements are combined with each other will be referred to as a sensing part in the following description. Sensing elements are not the only elements that can be combined in the sensing part described in this example embodiment and the following example embodiments, and a plurality of structures, each composed of a sensing element and a sound insulation member, like the sensing part 20 shown in FIG. 13 and the sensing part 21 shown in FIG. 14, may be combined with each other. Therefore, in this example embodiment and the following example embodiments, each of a plurality of light-receiving elements, each of a plurality of sensing parts 20, and each of a plurality of sensing parts 21 combined in a sensing part will be collectively referred to as a sensing structure.

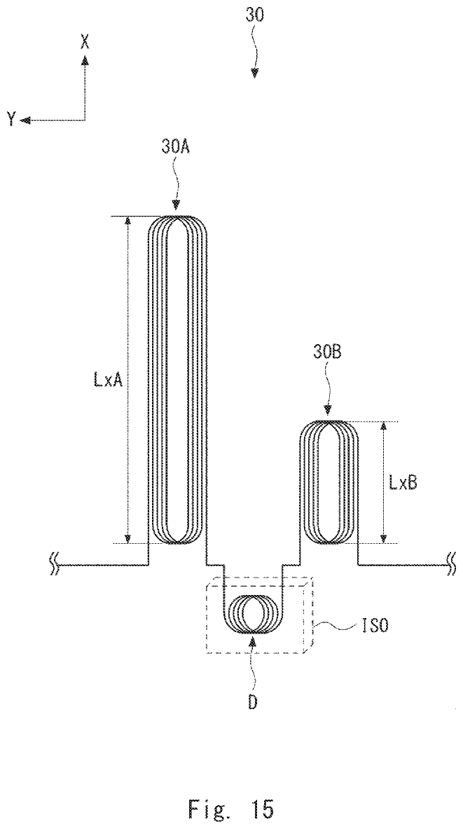

FIG. 15 schematically shows a configuration of a sensing part 30, which is a first configuration example according to the third example embodiment. The sensing part 30 is an example in which two sensing elements 30A and 30B whose lengths of long diameters are different from each other are combined with each other. While the sensing elements 30A and 30B are formed in a way similar to those of the first or second example embodiment, the lengths of the long diameters are different from each other. In this example, the long diameter LxA of the sensing element 30A is larger than the long diameter LxB of the sensing element 30B. The sensing elements 30A and 30B are arranged in line with each other in the Y direction in such a way that the long diameters thereof are along the axis parallel to the X direction. The sensing elements 30A and 30B are arranged to be close to each other in such a way that they can sense sound waves in the same sound field.

When the sensing elements 30A and 30B are connected in series and perform sensing by one common interrogator, a dummy section D having a predetermined light storage time is provided between them. The predetermined light storage time is a time longer than the light pulse width Wp with a sufficient margin. A general example embodiment of the dummy section D is a delay line formed of an optical fiber. When, for example, the light pulse width Wp is 40 ns, since the length of the light pulse in the optical fiber is about 8 m, the optical fiber delay line is set to be 8 m or longer. The installment of the dummy section prevents one light pulse from propagating across the sensing elements 30A and 30B, whereby it is possible to prevent leakage of sensing information of the sound waves in the sensing elements 30A and 30B. Further, in order to prevent sound waves from being sensed by the dummy section D itself, it is desirable that the dummy section D be housed inside a sound insulation member IS0 as necessary.

Even when the timing when the light pulse passes through the sensing element 30A is slightly deviated from the timing when it passes through the sensing element 30B, the sensing elements 30A and 30B are able to sense the substantially same state of sound wave since the speed at which light propagates through an optical fiber is much higher than the speed at which a sound wave is changed. Further, the long diameter L×A of the sensing element 30A is larger than the long diameter L×B of the sensing element 30B as described above. Therefore, if the optical fiber length of the sensing element 30A is substantially the same as that of the sensing element 30B, the sensing element 30A is a relatively wide band and has a low sensitivity and the sensing element 30B is a relatively narrow band and has a high sensitivity. Therefore, according to this configuration, by combining sensing elements whose sensing bands and sensitivities are different from each other, sound waves can be sensed under wider conditions.

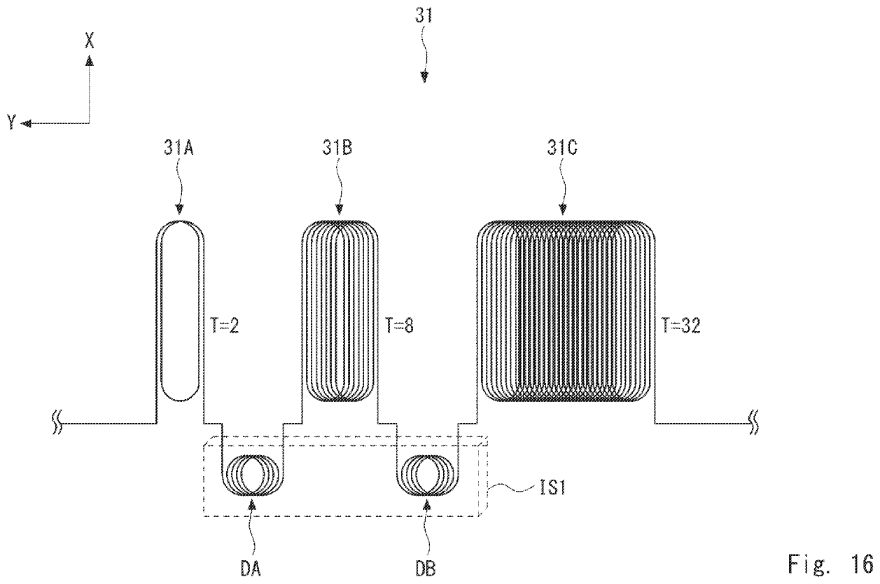

FIG. 16 schematically shows a configuration of a sensing part 31, which is a second configuration example according to the third example embodiment. In this configuration example, a parallel arrangement of a plurality of sensing elements having the same outer shape but different numbers of turns will be described.

The sensing part 31 includes three sensing elements 31A-31C formed in a way similar to those in the first or second example embodiment. The sensing element 31C includes a configuration shown by the design value in Calculation example 1 (number of turns 32). On the other hand, the sensing elements 31A and 31B are configured in such a way that the outer shapes thereof are the same as that of the sensing element 31C but the numbers of turns thereof become smaller than the number of turns of the sensing element 31C. In this example, the number of turns of the sensing element 31B is set to be 8 and the number of turns of the sensing element 31A is set to be 2. That is, since the numbers of turns of the sensing elements 31A and 31B are smaller than the number of turns 32, which is the number for maximizing the sensitivity, the sensing elements 31A and 31B have sensitivities lower than that of the sensing element 31C. The sensing elements 31A-31C are arranged in line with one another in the Y direction in such a way that the long diameters thereof are along the axis parallel to the X direction.

When the sensing elements 31A-31C are connected in series and perform sensing by one common interrogator, a dummy section formed of an optical fiber which is much longer than the light pulse width Wp is provided between sensing elements adjacent to each other, like in the first configuration example of the third example embodiment. The reason why the dummy section needs to be provided has already been described above. In this configuration, a dummy section DA is provided between the sensing element 31A and the sensing element 31B and a dummy section DB is provided between the sensing element 31B and the sensing element 31C. Further, in order to prevent sound waves from being sensed by the dummy sections DA and DB, the dummy sections DA and DB are preferably housed inside a sound insulation member IS1.

In general, an output value of a high-sensitive sensing element tends to be saturated when a large amplitude is input thereto and an output value of a low-sensitive sensing element is unlikely to be saturated even when a large amplitude is input thereto. Therefore, in this configuration, a configuration of a sensing part in which sensing elements having different sensitivities are combined with each other is employed. Accordingly, a wide dynamic range can be achieved.

Lowering sensitivity can be achieved by making the light pulse width Wp shorter than Lt. However, in order to narrow the light pulse width, there may be physical limitations such as the need to increase the operation speed of an optical modulator and a driving circuit thereof. Further, changing the light pulse width Wp might affect other sensor characteristics. On the other hand, by employing this example embodiment, a wide dynamic range can be achieved without changing the light pulse width Wp.

While the example in which two or three types of sensing elements are combined with each other has been described in this example embodiment, a configuration in which four or more types of sensing elements are combined with one another may be naturally employed.

### Fourth Example Embodiment

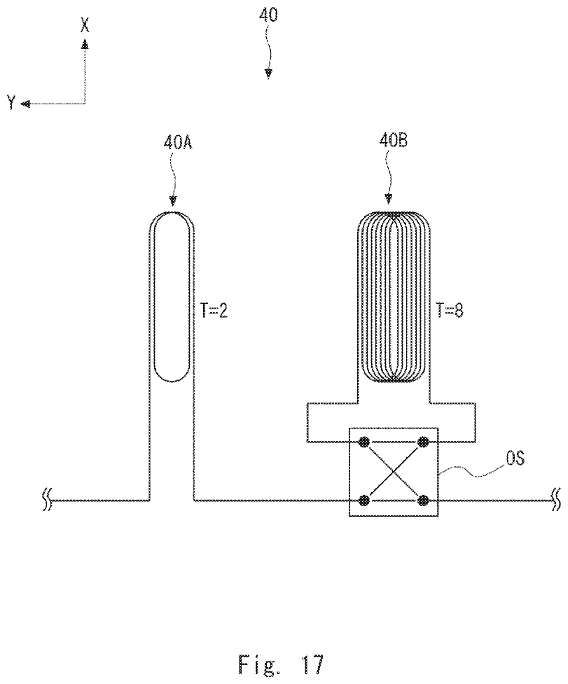

In the configurations shown in FIGS. 15 and 16, the parameters of the sensing elements are fixed. On the other hand, in this example embodiment, a sensing part capable of switching parameters of sensing elements by combining them with an optical switch will be described. FIG. 17 schematically shows a configuration of a sensing part 40 according to a fourth example embodiment. This example is a configuration for the purpose of switching the characteristics by the optical switch instead of preparing a plurality of sensing elements with different numbers of turns as shown in FIG. 16. The sensing part 40 includes two sensing elements 40A and 40B and an optical switch OS. The sensing elements 40A and 40B respectively have configurations similar to those of the sensing elements 31A and 31B of the sensing part 31 according to the fourth example embodiment. In the sensing part 40, a dummy section is not provided between the sensing element 40A and the sensing element 40B.

The optical switch OS, which is, for example, an optical crossbar switch, is able to switch between a bar state and a cross state. In the bar state, a light pulse passes through only the sensing element 40A whose number of turns is two, whereby sound waves are sensed with a relatively low sensitivity. In the cross state, the light pulse passes through the sensing element 40A whose number of turns is two and the sensing element 40B whose number of turns is eight, whereby sound waves can be sensed with a higher sensitivity.

That is, according to this configuration, parameters of the sensing elements can be switched as necessary. This enables flexible operations such as sensing sound waves in a high sensitivity in a normal state and lowering the sensitivity when a large input has been detected.

An example embodiment in which a plurality of sensing elements having directivities described above are used in combination with each other in different directions will be described below. A minimum unit of sensing elements that form a sensing part having directivities is a configuration shown in FIG. 13, and it is shown by a symbol like 50A in drawings. Since the method of connecting a plurality of sensing elements and providing a dummy section when they are connected in a row (in series) as necessary have already been described above, the descriptions thereof will be omitted in the following example embodiments.

### Fifth Example Embodiment

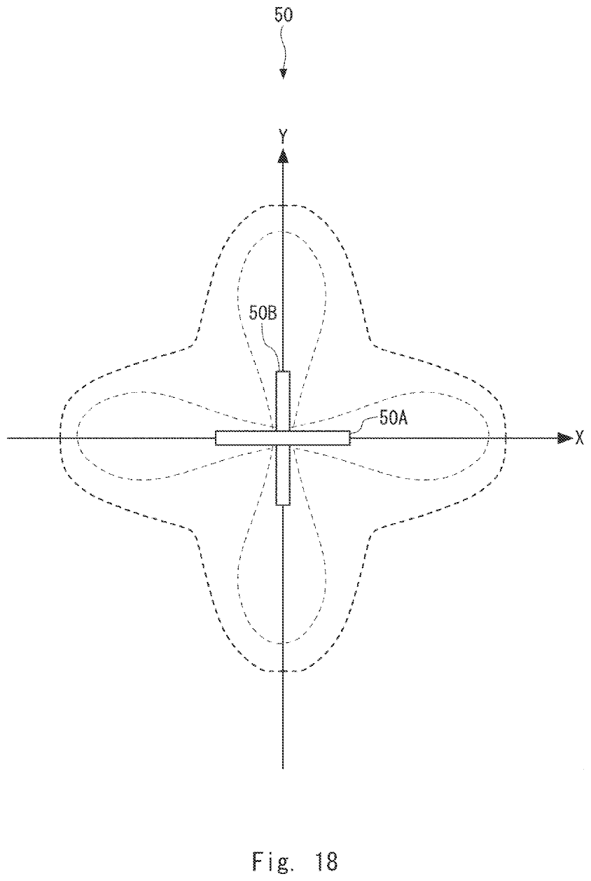

In this example embodiment, a sensing part in which sensing elements having directivities are disposed so that they intersect with each other at different angles, thereby enabling two-dimensional orientation identification will be described. FIG. 18 schematically shows a configuration of a first example of a sensing part according to a fifth example embodiment. A sensing part 50 shown in FIG. 18 includes two sensing elements, that is, a sensing element 50A (this is referred to also as a first sensing element) and a sensing element 50B (this is referred to also as a second sensing element), which are arranged so as to be perpendicular to each other. Specifically, the sensing element 50A is disposed along the X axis and the sensing element 50B is disposed along the Y axis. Accordingly, two-dimensional orientation identification can be achieved. When the space can be substantially expressed by two dimensions, like in a shallow sea area, it is sufficient that two-dimensional orientation identification be achieved.

The sensing elements 50A and 50B are disposed to be close to each other as much as possible in such a way that they can sense sound waves in the same sound field. The sensing elements 50A and 50B may be connected to an interrogator independently from each other, may be connected to one interrogator in a row (in series), or a mixture thereof. However, when they are connected in a row (in series), a dummy section is appropriately provided in order to secure sufficient separation from adjacent sensing elements. The meaning of the dummy section and points to be noted when it is formed have already been described in the third example embodiment.

According to this configuration, sound waves in different directions can be sensed separately from each other, whereby it is possible to provide the acoustic sensor capable of analyzing the output of each of the sensing elements and identifying incoming directions of sound waves.

The thin broken lines in FIG. 18 show isosensitivity curves of the respective sensing elements and the thick broken line in FIG. 18 shows an isosensitivity curve of the entire sensing part obtained by synthesizing the isosensitivity curves of the two sensing elements. In this manner, by arranging two sensing elements, sound waves coming from various angles can be sensed on the X-Y plane.

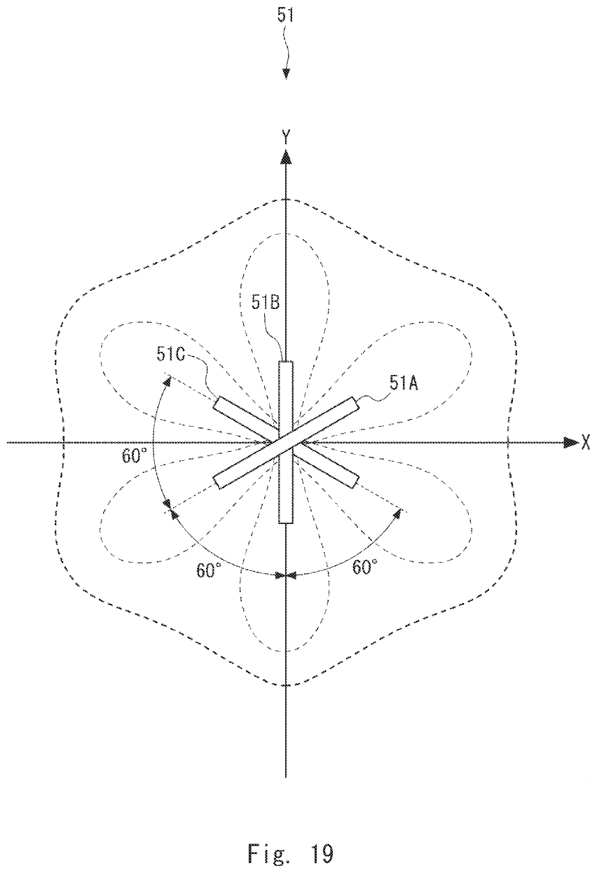

Next, FIG. 19 schematically shows a configuration of a second example of the sensing part according to the fifth example embodiment. A sensing part 51, which is a modified example of the sensing part 50, includes a larger number of sensing elements. The sensing part 51 includes three sensing elements 51A-51C (they are referred to also as first to third sensing elements, respectively), which are disposed on the X-Y plane in such a way that their orientations differ from one another by 60°.

The thin broken lines in FIG. 19 show isosensitivity curves of the respective sensing elements and the thick broken line in FIG. 19 shows an isosensitivity curve of the entire sensing part obtained by synthesizing the isosensitivity curves of the three sensing elements. In this manner, by radially arranging the three sensing elements, sound waves coming from various angles can be sensed on the X-Y plane.

Further, while there are dips in the isosensitivity curve of the sensing part 50, the isosensitivity curve of the sensing part 51 composed of six sensing elements has less dips and its shape is close to a circle. This is because, since the intervals between angles at which the sensing elements are arranged have been reduced, the area where the sensitivity is weak has been decreased. Therefore, according to this configuration, the shape of the synthetic isosensitivity curve is much closer to a circle, which allows orientation identification to be performed more evenly than in the sensing part 50.

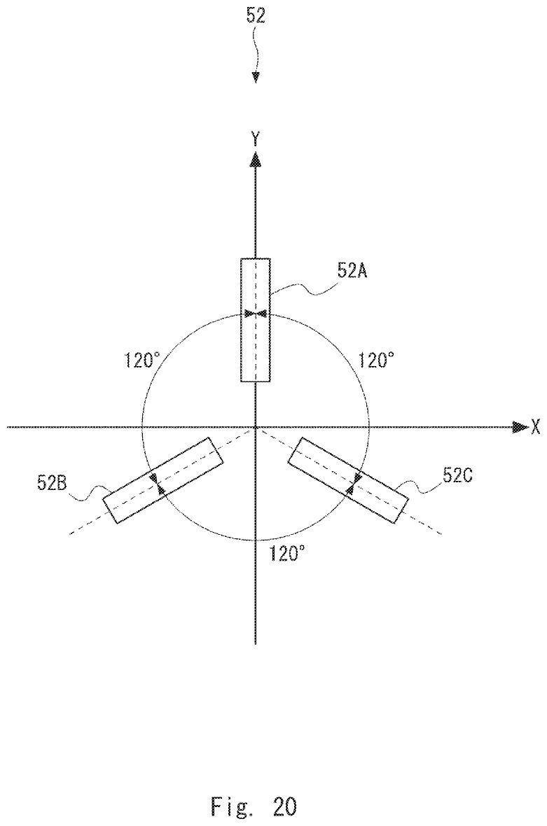

Next, FIG. 20 schematically shows a configuration of a third example of the sensing part according to the fifth example embodiment. A sensing part 52 includes three sensing elements 52A-52C (they are referred to also as first to third sensing elements, respectively). The sensing elements 52A-52C are arranged in such a way that their orientations differ from one another by 120° on the X-Y plane with the origin as the center. The sensing elements used here are sensing elements designed so as not to pick up sound on the back side as shown in FIG. 14. Therefore, in the sensing part 52, the size of the sensing elements is halved than that of the sensing part 51. The sound absorbing materials of three elements may be integrated and formed.

According to this configuration, while the directional dependency of the sensitivity becomes stronger than that of the sensing part 51, an economical sensing part can be provided by reducing the size of the sensing elements.

### Sixth Example Embodiment

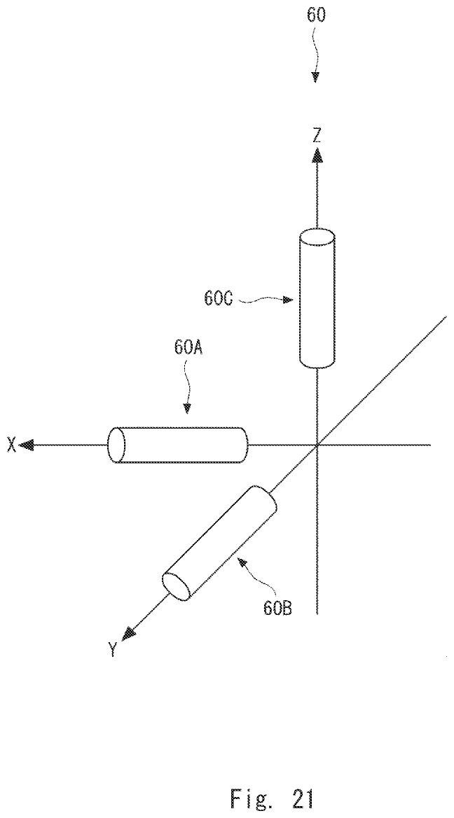

In the fifth example embodiment, the sensing part capable of achieving two-dimensional orientation identification has been described. In a sixth example embodiment, a sensing part that achieves three-dimensional orientation identification will be described. FIG. 21 schematically shows a configuration of a first example according to the sixth example embodiment. The sensing part 60 includes three sensing elements 60A-60C (they are referred to also as first to third sensing elements, respectively), similar to the sensing part 51 or 52, disposed so as to be orthogonal to each other. Specifically, the sensing element 60A is disposed so as to be along the X axis, the sensing element 60B is disposed so as to be along the Y axis, and the sensing element 60C is disposed so as to be along the Z axis (third direction). Accordingly, the three-dimensional orientation identification can be achieved. The sensing elements 60A-60C are disposed to be close to one another as much as possible in such a way that sound waves in the same sound field can be sensed.

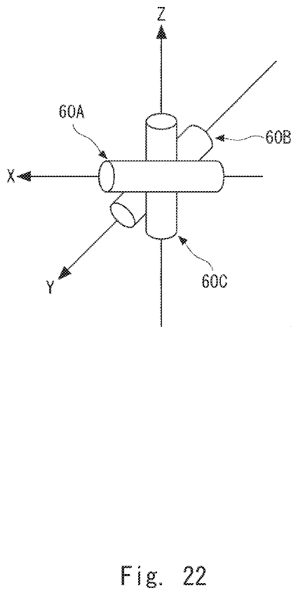

If the sensing elements 60A-60C can be combined with one another, they may be combined and arranged as shown in FIG. 22. In this case, the size of the entire sensing part can be reduced. The same holds true for the configurations described below.

While isosensitivity curves of the respective sensing elements and an isosensitivity curve of the entire sensing part obtained by synthesizing them are not shown in FIGS. 21 and 22, an idea similar to that in, for example, FIG. 18 can be expanded to three dimensions. It therefore becomes possible to sense sound waves coming from various angles in the three-dimensional space.

When the number of elements is further increased, the synthetic isosensitivity curve approaches a sphere, which allows sound waves to be sensed more evenly. However, depending on the situation where they are used, there may be a case in which it is desired to grasp a specific direction in detail but it is sufficient that another specific direction be grasped roughly so that the sensing part can be obtained economically. When, for example, the X-Y plane is investigated in detail but it is sufficient that the Z-axis direction be grasped roughly, the directivity of the sensing element facing the Z-axis direction may be reduced to cause one sensing element to cover a wider area so that the number of elements may be reduced.

The sensing elements 60A-60C may be connected to interrogators independently from one another, connected to one interrogator in a row (in series), or a mixture thereof. When they are connected in a row (in series), dummy sections are appropriately provided in order to ensure sufficient separation from adjacent sensing elements. The meaning of the dummy sections and points to be noted when they are formed have been described in the third example embodiment.

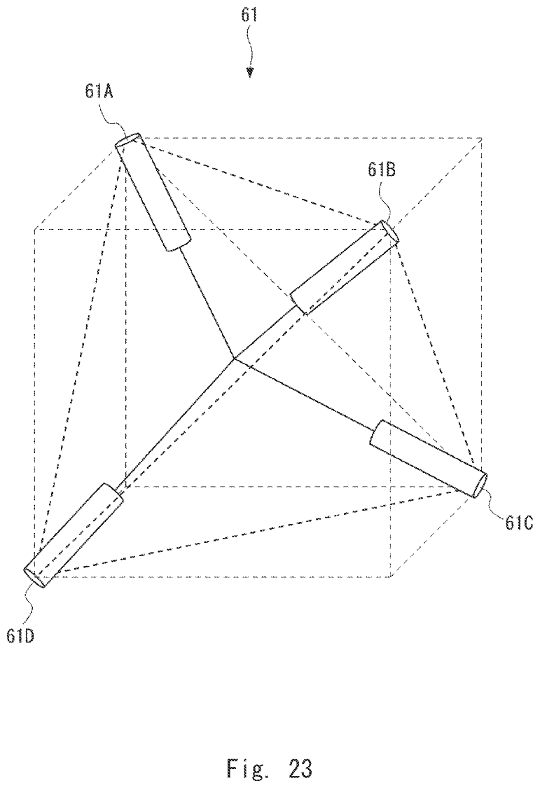

Next, FIG. 23 schematically shows a configuration of a second example of the sensing part according to the sixth example embodiment. A sensing part 61, which has a configuration in which three-dimensional orientation identification can be achieved, is composed of four sensing elements 61A-61D (they are referred to also as first to fourth sensing elements, respectively). The sensing elements 61A-61D are arranged in such a way that their long diameters are along the directions toward different vertices of a regular tetrahedron about the center point. While these four elements are drawn slightly apart from one another for the sake of convenience of explanation in FIG. 23, it is desirable that they actually be disposed to be close to each other as much as possible while preventing shadows from occurring.

According to this configuration, it is possible to distinguish sensing of sound waves in the sensing elements 61A-61D having directivities in different directions, whereby it is possible to obtain an acoustic sensor capable of synthesizing results of sensing in each of the sensing elements and identifying incoming directions of the three-dimensional sound waves.

Further, the number of sensing elements used in the sensing part 61 is larger than that of the sensing part 60, which allows orientation identification to be performed more evenly.

The fifth and sixth example embodiments are techniques for achieving orientation identification by arranging sensing elements having directivities in orientations different from one another. Needless to say, the techniques described in the third and fourth example embodiments, that is, the technique of combining the sensing elements having different parameters and the technique of making element parameters variable may be combined with the techniques described in the fifth and sixth example embodiments.

### Seventh Example Embodiment

In this example embodiment, a sensing part capable of controlling directivity in an arithmetic operation will be described. A sensing part 70 according to a seventh example embodiment is able to control its directivity by an arithmetic operation by a principle similar to that of a phased array antenna.

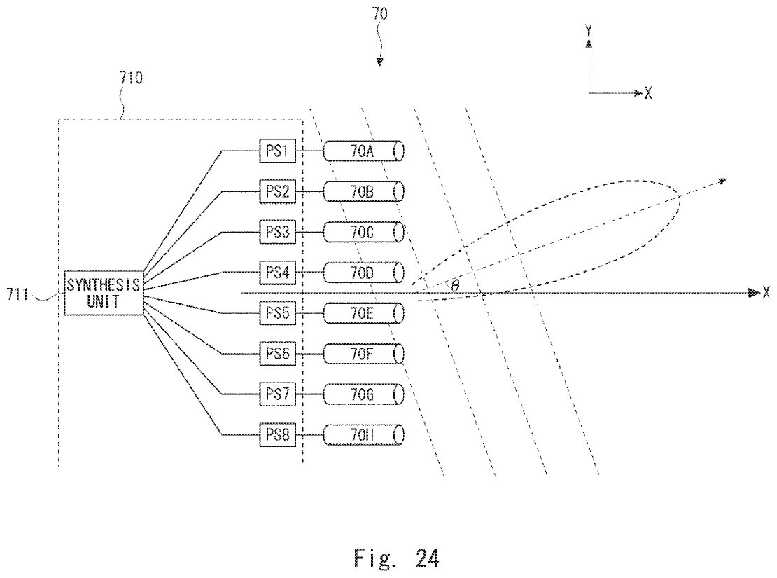

FIG. 24 schematically shows a configuration of the sensing part 70 according to the seventh example embodiment. The sensing part 70 includes eight sensing elements 70A-70H having directivity in the X direction aligned in the Y direction. While each of the sensing elements 70A-70H may be a bidirectional one as shown in FIG. 13 or a unidirectional one as shown in FIG. 14, it is considered that the configuration in which unidirectional elements shown in FIG. 14 are arranged by integrating a sound absorbing material is more economical since it is considered that it is not always necessary to collect sound from the back side.

Like in the examples of the above-mentioned combined sensing part, the sensing elements may be connected in series to one interrogator, may be connected to a plurality of interrogators, or a mixture thereof as long as the sensing elements are independent from each other.

In this configuration, outputs from the sensing elements 70A-70H are shifted by virtual phase shifters PS1-PS8 by a predetermined time and then added up (by a synthesis unit 711) by an arithmetic operation inside the arithmetic unit 710. Accordingly, the orientation of the directivity can be changed by only changing the time shift amount, which is an arithmetic parameter, without changing the physical orientations of the sensing elements 70A-70H. It is needless to say that the arithmetic unit 710 and the conversion unit 711 may be provided in the interrogator 1.

While the sensing elements are linearly (in a one-dimensional manner) aligned in FIG. 24 for the sake of convenience of the explanation, they may be naturally arranged in a plane (in a two-dimensional manner), like a two-dimensional phased array antenna.

It is needless to say that the techniques described in the third and fourth example embodiments, that is, the technique of combining the sensing elements having different parameters and the technique of making element parameters variable may be combined with each other.

### Other Example Embodiments

Note that the present invention is not limited to the aforementioned example embodiments and may be changed as appropriate without departing from the spirit of the present invention. For example, while the example in which the dummy section composed of the optical fiber longer than the spatial resolution is provided between two sensing elements connected in series to one interrogator has been described in, for example, the third example embodiment, the method of providing the dummy section is not limited thereto. The dummy section may be composed of a desired optical component other than the optical fiber as long as it is able to store light for a predetermined period of time.

By arranging sensing parts capable of achieving two-dimensional orientation identification in such a way that they are perpendicular to one another, like the sensing parts 50-52, sensing parts capable of achieving three-dimensional orientation identification may be formed.

In the sensing parts 50 and 51, like in the second example embodiment, two sensing elements are aligned on a straight line. Therefore, like in the second example embodiment, sound may be input from a known orientation in advance and amplitude output from the respective sensing elements may be set as leakage coefficients. Likewise, in the sensing part 52, a sound wave may be emitted from a direction having directivity of each sensing element, the output of an element that should be originally sensed and the output of the other elements may be recorded, and they may be set as leakage coefficients. When, for example, a sound wave is emitted from the + direction of the Y axis, it should be sensed by the sensing element 52A. If it is sensed by the sensing elements 52B and 52C, they are leakage components. In this way, by calibrating and weighting leakage coefficients between the respective elements and synthesizing the output of the respective sensing elements by weighting them, the leakage components can be reduced and eliminated.

The length of optical fibers that can be sensed by a single interrogator is limited by the sampling frequency. Therefore, the sensing operation may be performed by a plurality of interrogators as appropriate in a distributed manner.

While the use of an interrogator based on the principle of receiving light backscattered from the optical fiber has been described in the present invention, since this invention discloses a technique of a method of providing a sensing part including a new function of sensing, with directivity, a phenomenon that an optical fiber is stretched or compressed by incoming sound waves, any method of sensing stretch or compression of an optical fiber may be used. A system of receiving light that is transmitted through an optical fiber may be used.

Needless to say, when the optical fiber of the sensing part is helically wound, it is possible to detect vibrations having directivity, although the directivity is lowered, as disclosed in Patent Literature 4.

Further, the whole or part of the above example embodiments can be described as, but not limited to, the following supplementary notes.

(Supplementary Note 1) An acoustic sensor comprising a sensing part including a sensing element composed of an optical fiber; and an interrogator that is connected to the sensing part, sends a pulse light to the sensing part, and detects a sound wave vibration to be sensed by the sensing part based on a reflected return light from the sensing part, wherein the sensing element is composed of the optical fiber folded in such a way that it reciprocates a plurality of number of times along a directivity direction in which directional sensitivity is exhibited.

(Supplementary Note 2) The acoustic sensor according to Supplementary Note 1, wherein a dimension of a part of the sensing element where the optical fiber reciprocates a plurality of number of times along the direction in which the directional sensitivity is exhibited is substantially equal to or smaller than a value obtained by dividing the speed of an acoustic wave in a medium by twice an upper-limit value of an acoustic wave frequency band to be observed.

(Supplementary Note 3) The acoustic sensor according to Supplementary Note 1 or 2, wherein the total length of the optical fiber that composes the sensing element is substantially equal to the pulse length of the pulse light that propagates through the optical fiber.

(Supplementary Note 4) The acoustic sensor according to any one of Supplementary Notes 1 to 3, wherein the sensing element is formed by the optical fiber wound in an oval shape whose long diameter is the directivity direction.

(Supplementary Note 5) The acoustic sensor according to any one of Supplementary Notes 1 to 4, wherein the optical fiber that composes the sensing element is fixed and protected by resin potting.

(Supplementary Note 6) The acoustic sensor according to any one of Supplementary Notes 1 to 3, wherein the sensing element is composed of the optical fiber wound in a flat swirl shape on a sheet member that can be wound into a cylindrical shape, and the sheet member is wound, fixed, and protected in such a way that the long diameter direction of the flat swirl is a cylindrical longitudinal direction formed by winding the sheet member.

(Supplementary Note 7) The acoustic sensor according to any one of Supplementary Notes 1 to 4, wherein the sensing element is composed of an optical fiber ribbon including a plurality of optical fibers arranged in parallel to each other and a light folded-back part connected to both ends of the optical fiber ribbon.

(Supplementary Note 8) The acoustic sensor according to Supplementary Note 7, wherein the light folded-back part is composed of a silicon optical circuit.

(Supplementary Note 9) The acoustic sensor according to Supplementary Note 7, wherein the light folded-back part is composed of a quartz optical circuit.

(Supplementary Note 10) The acoustic sensor according to Supplementary Note 7, wherein the light folded-back part is composed of an optical fiber ribbon.

(Supplementary Note 11) The acoustic sensor according to any one of Supplementary Notes 1 to 10, wherein the sensing part includes one or more sensing structure provided therein, each including the at least one sensing element.

(Supplementary Note 12) The acoustic sensor according to Supplementary Note 11, wherein the sensing structure is composed of the sensing element and a sound insulation member, and in the sensing structure, one of sensitivity directivities, which are two front and back directions when viewed from the sensing element, is blocked by providing the sound insulation member.

(Supplementary Note 13) The acoustic sensor according to Supplementary Note 12, wherein the sensing structure includes first and second sensing elements, which are the sensing elements, arranged on a straight line in such a way that the directivity directions are the same direction, and the sound insulation member is provided between the first and second sensing elements.

(Supplementary Note 14) The acoustic sensor according to Supplementary Note 13, wherein

a first transmittance of a sound wave vibration that is transmitted through the sound insulation member and reaches the first sensing element and a second transmittance of a sound wave vibration that is transmitted through the sound insulation member and reaches the second sensing element are calibrated in advance, results of sensing in the first sensing element are obtained by excluding sensing by vibration that is transmitted through the sound insulation member and reaches the first sensing element using the first transmittance, and results of sensing in the second sensing element are obtained by excluding sensing by vibration that is transmitted through the sound insulation member and reaches the second sensing element using the second transmittance.

(Supplementary Note 15) The acoustic sensor according to any one of Supplementary Notes 11 to 14, wherein a plurality of sensing structures are arranged so as to sense acoustic vibrations in the same field.

(Supplementary Note 16) The acoustic sensor according to Supplementary Note 15, wherein the plurality of sensing structures whose dimensions of the directivity directions of the sensing elements are different from each other are combined with each other, with the directivity directions being aligned.

(Supplementary Note 17) The acoustic sensor according to Supplementary Note 15, wherein the plurality of sensing structures in which the sensing elements have optical fiber reciprocation numbers different from each other, with the directivity directions being aligned.

(Supplementary Note 18) The acoustic sensor according to Supplementary Note 15, wherein the plurality of sensing structures are connected in cascade, a dummy section that stores light is provided between the sensing structures adjacent to each other, and a time during which the dummy section stores light is longer than the pulse length of the pulse light.

(Supplementary Note 19) The acoustic sensor according to Supplementary Note 18, wherein the dummy section is composed of an optical fiber and is held in a sound-insulated environment.

(Supplementary Note 20) The acoustic sensor according to Supplementary Note 15, wherein the sensing part is composed of the plurality of sensing structures and an optical switch, and the optical switch enables incorporation of a specific sensing structure to be selected.

(Supplementary Note 21) The acoustic sensor according to Supplementary Note 15, wherein the plurality of sensing structures are combined so as to be arranged in directions in which their directivities are different from each other on a two-dimensional plane or in a three-dimensional space.

(Supplementary Note 22) The acoustic sensor according to Supplementary Note 15, wherein the plurality of sensing structures are combined so as to be arranged in directions in which their directivities are orthogonal to each other on a two-dimensional plane or in a three-dimensional space.

(Supplementary Note 23) The acoustic sensor according to Supplementary Note 21 or 22, wherein the plurality of sensing structures are radially arranged around a predetermined point.

(Supplementary Note 24) The acoustic sensor according to Supplementary Note 23, wherein first to third sensing structures are arranged on a two-dimensional plane in such a way that their directivities differ from one another by 60°.

(Supplementary Note 25) The acoustic sensor according to Supplementary Note 23, wherein first to third sensing structures are arranged on a two-dimensional plane in such a way that their directivities differ from one another by 120°.

(Supplementary Note 26) The acoustic sensor according to Supplementary Note 23, wherein first to fourth sensing structures are arranged in such a way that the directivities thereof face directions connecting the center of a regular tetrahedron and four vertices thereof, the directions being different from one another.

(Supplementary Note 27) The acoustic sensor according to Supplementary Note 15, wherein the plurality of sensing structures are arranged on a plane vertical to directivities in such a way that their directivities are aligned, the interrogator phase-shifts sound wave sensing waveforms obtained in the plurality of sensing structures by a predetermined amount, thereby causing the entire plurality of sensing structures to function as one sensing part, and the acoustic sensor controls the directivity of the sensing part by changing the phase shift amount of each of the sound wave sensing waveforms.

While the present invention has been described above with reference to the example embodiments, the present invention is not limited by the aforementioned descriptions. Various changes that can be understood by one skilled in the art may be made to the configurations and the details of the present invention within the scope of the invention.

This application is based upon and claims the benefit of priority from Japanese Patent Application No. 2019-196746, filed on Oct. 29, 2019, the disclosure of which is incorporated herein in its entirety by reference.

### REFERENCE SIGNS LIST

RT Light Folded-back Part Package of Sensing Element using Optical Fiber Ribbon
D, DA, DB Dummy Section
F, F1, F2 Optical Fiber
FG Plurality of Optical Fibers
IS, IS0, IS1 Sound Insulation Member
L1, L2 Straight Line Part
MM Micro Mirror
OS Optical Switch
P Light Pulse
PS1-PS8 Phase Shifter
ST Sheet Member
SUB Substrate
VA, 7A, 7B, 7C, 7D V Groove Array
VG V Groove
WG SiO₂ Optical Waveguide
1 Interrogator
5, 9A, 9B Optical Fiber Ribbon
5A Coating
6A, 6B Si Optical Circuit
8A and 8B Folded-back Circuit
10, 11, 20, 21, 30, 31, 40, 50, 51, 52, 60, 61, 70 Sensing Part
10A-10C, 20A, 20B, 30A, 30B, 31A-31C, 40A, 40B, 50A, 50B, 51A-51C, 52A-52C, 60A-60C, 61A-61D, 70A-70H Sensing Element
100 Acoustic Sensor
710 Arithmetic Unit
711 Synthesis Unit

What is claimed is:

1. An acoustic sensor comprising:
a sensing part including a sensing element composed of an optical fiber; and
an interrogator that is connected to the sensing part, sends a pulse light to the sensing part, and detects a sound wave vibration to be sensed by the sensing part based on a reflected return light from the sensing part,
wherein the sensing element is composed of the optical fiber folded in such a way that it reciprocates a plurality of number of times along a directivity direction in which directional sensitivity is exhibited.

2. The acoustic sensor according to claim 1, wherein a dimension of a part of the sensing element where the optical fiber reciprocates a plurality of number of times along the direction in which the directional sensitivity is exhibited is substantially equal to or smaller than a value obtained by dividing the speed of an acoustic wave in a medium by twice an upper-limit value of an acoustic wave frequency band to be observed.

3. The acoustic sensor according to claim 1, wherein the total length of the optical fiber that composes the sensing element is substantially equal to the pulse length of the pulse light that propagates through the optical fiber.

4. The acoustic sensor according to claim 1, wherein the sensing element is formed by the optical fiber wound in an oval shape whose long diameter is the directivity direction.

5. The acoustic sensor according to claim 1, wherein the optical fiber that composes the sensing element is fixed and protected by resin potting.

6. The acoustic sensor according to claim 1, wherein
the sensing element is composed of the optical fiber wound in a flat swirl shape on a sheet member that can be wound into a cylindrical shape, and
the sheet member is wound, fixed, and protected in such a way that the long diameter direction of the flat swirl is a cylindrical longitudinal direction formed by winding the sheet member.

7. The acoustic sensor according to claim 1, wherein the sensing element is composed of an optical fiber ribbon including a plurality of optical fibers arranged in parallel to each other and a light folded-back part connected to both ends of the optical fiber ribbon.

8. The acoustic sensor according to claim 7, wherein the light folded-back part is composed of a silicon optical circuit.

9. The acoustic sensor according to claim 7, wherein the light folded-back part is composed of a quartz optical circuit.

10. The acoustic sensor according to claim 7, wherein the light folded-back part is composed of an optical fiber ribbon.

11. The acoustic sensor according to claim 1, wherein the sensing part includes one or more sensing structure provided therein, each including the at least one sensing element.

12. The acoustic sensor according to claim 11, wherein
the sensing structure is composed of the sensing element and a sound insulation member, and
in the sensing structure, one of sensitivity directivities, which are two front and back directions when viewed from the sensing element, is blocked by providing the sound insulation member.

13. The acoustic sensor according to claim 12, wherein
the sensing structure includes first and second sensing elements, which are the sensing elements, arranged on a straight line in such a way that the directivity directions are the same direction, and
the sound insulation member is provided between the first and second sensing elements.

14. The acoustic sensor according to claim 13, wherein
a first transmittance of a sound wave vibration that is transmitted through the sound insulation member and reaches the first sensing element and a second transmittance of a sound wave vibration that is transmitted through the sound insulation member and reaches the second sensing element are calibrated in advance,
results of sensing in the first sensing element are obtained by excluding sensing by vibration that is transmitted through the sound insulation member and reaches the first sensing element using the first transmittance, and
results of sensing in the second sensing element are obtained by excluding sensing by vibration that is transmitted through the sound insulation member and reaches the second sensing element using the second transmittance.

15. The acoustic sensor according to claim 11, wherein a plurality of sensing structures are arranged so as to sense acoustic vibrations in the same field.

16. The acoustic sensor according to claim 15, wherein the plurality of sensing structures whose dimensions of the directivity directions of the sensing elements are different from each other are combined with each other, with the directivity directions being aligned.

17. The acoustic sensor according to claim 15, wherein the plurality of sensing structures in which the sensing elements have optical fiber reciprocation numbers different from each other, with the directivity directions being aligned.

18. The acoustic sensor according to claim 15, wherein
the plurality of sensing structures are connected in cascade,
a dummy section that stores light is provided between the sensing structures adjacent to each other, and
a time during which the dummy section stores light is longer than the pulse length of the pulse light.

19. The acoustic sensor according to claim 18, wherein the dummy section is composed of an optical fiber and is held in a sound-insulated environment.

20. The acoustic sensor according to claim 15, wherein
the sensing part is composed of the plurality of sensing structures and an optical switch, and
the optical switch enables incorporation of a specific sensing structure to be selected.

21.-27. (canceled)
